(19) United States
(12) Patent Application Publication
(10) Pub. No.: US 2006/0190700 A1
(43) Pub. Date: Aug. 24, 2006

(54) Handling permanent and transient errors using a SIMD unit

(75) Inventors: Erik Altman, Danbury, CT (US); Gheorghe C. Cascaval, Carmel, NY (US); Luis Henrique Ceze, Urbana, IL (US); Vijayalakshmi Srinivasan, New York, NY (US)

Correspondence Address: MICHAEL J. BUCHENHORNER, ESQ;HOLLAND & KNIGHT, 701 BRICKELL AVENUE, MIAMI, FL, 33131, US

(73) Assignee: International Business Machines Corporation

(21) Appl. No.: 11/063,122

(22) Filed: Feb. 22, 2005

(51) Int. Cl. G06F 15/00

(52) U.S. Cl. 712/7

(57) ABSTRACT

A method for handling permanent and transient errors in a microprocessor is disclosed. The method includes reading a scalar value and a scalar operation from an execution unit of the microprocessor. The method further includes writing a copy of the scalar value into each of a plurality of elements of a vector register of a Single Instruction Multiple Data (SIMD) unit of the microprocessor and executing the scalar operation on each scalar value in each of the plurality of elements of the vector register of the SIMED unit using a vector operation. The method further includes comparing each result of the scalar operation on each scalar value in each of the plurality of elements of the vector register and detecting a permanent or transient error if all of the results are not identical.

### STATEMENT REGARDING FEDERALLY SPONSORED RESEARCH OR DEVELOPMENT

This invention was made with Government support under Contract No.: NBCH3039004 awarded by the U.S. Department of the Interior National Business Center (DOI/NBC). The Government has certain rights in this invention.

### CROSS-REFERENCE TO RELATED APPLICATIONS

Not Applicable.

### INCORPORATION BY REFERENCE OF MATERIAL SUBMITTED ON A COMPACT DISC

Not Applicable.

### FIELD OF THE INVENTION

The invention disclosed broadly relates to the field of computer architecture and more particularly relates to the field of handling permanent and transient errors in microprocessors.

### BACKGROUND OF THE INVENTION

As silicon technology advances, microprocessor device sizes decrease and the rate of permanent errors and transient errors increases. These errors are manifested mainly as bit flips in latches or errors in logic evaluations. This problem is currently being approached mainly through circuit-level protection and redundancy, including both temporal redundancy and redundant logic.

The issue of redundant execution in superscalar processors is being explored by the computer architecture community in many ways. Approaches explored include using replicated functional units, dynamically replicating instructions at issue time, replicating the whole instruction stream and comparing periodically or using an idle floating-point unit to perform redundant integer computation. None of these approaches, however, adequately address the problem of permanent and transient errors in microprocessors.

One prior approach is described in the document entitled “Dual use of superscalar datapath for transient-fault detection and recovery” published in the Proceedings of the 34th Annual International Symposium on Microarchitecture by Joydeep Ray, James C. Hoe and Babak Falsafi. This document describes a mechanism of duplicating instructions at the decode stage of the microprocessor pipeline. When instructions are decoded, they are replicated R times and all replicas proceed to execution independently. All replicas are consecutive in the reorder buffer (in-order completion unit) of the microprocessor. When all replicas of an instruction are complete, their results are compared and if the results do not match, an error is detected and a recovery action is triggered. The recovery action involves re-executing all instructions. currently in-flight in the processor. The drawback to this approach is that no error correction mechanism is proposed, and full re-execution is necessary to achieve a possibly correct execution, thereby increasing the processing burden on the system. Also, the execution of replicated instructions can cause major performance degradation.

Therefore, a need exists to overcome the problems with the prior art as discussed above, and particularly for a way to handle permanent and transient errors in microprocessors.

### SUMMARY OF THE INVENTION

Briefly, according to an embodiment of the present invention, a method for handling permanent and transient errors in a microprocessor is disclosed. The method includes reading a scalar value and a scalar operation from an execution unit of the microprocessor. The method further includes writing a copy of the scalar value into each of a plurality of elements of a vector register of a Single Instruction Multiple Data (SIMD) unit of the microprocessor and executing the scalar operation on each scalar value in each of the plurality of elements of the vector register of the SIMD unit using a vector operation. The method further includes comparing each result of the scalar operation on each scalar value in each of the plurality of elements of the vector register and detecting a permanent or transient error if all of the results are not identical.

In another embodiment of the present invention, a microprocessor for handling permanent and transient errors is disclosed. The information processing system includes a first execution unit configured for reading a scalar value and a scalar operation from another execution unit. The microprocessor further includes a Single Instruction Multiple Data (SIMD) unit, including a vector register, configured for accepting a copy of the scalar value into each of a plurality of elements of the vector register and executing the scalar operation on each scalar value in each of the plurality of elements of the vector register of the SIMD unit using a vector operation. The microprocessor further includes a second execution unit configured for comparing each result of the scalar operation on each scalar value in each of the plurality of elements of the vector register and detecting a permanent or transient error if all of the results are not identical.

In another embodiment of the present invention, a computer readable medium including computer instructions for handling permanent and transient errors in a microprocessor is disclosed. The computer instructions include reading a scalar value and a scalar operation from an execution unit of the microprocessor. The computer instructions further include writing a copy of the scalar value into each of a plurality of elements of a vector register of a Single Instruction Multiple Data (SIMD) unit of the microprocessor and executing the scalar operation on each scalar value in each of the plurality of elements of the vector register of the SIMD unit using a vector operation. The computer instructions further include comparing each result of the scalar operation on each scalar value in each of the plurality of elements of the vector register and detecting a permanent or transient error if all of the results are not identical.

The mapping between the original scalar instructions and the correspondent vector operations executed in the SIMD unit can be done either dynamically or statically. In the case of being done dynamically, a hardware controller translates the scalar instructions to be protected into vector instructions. It also has to decide what data needs to be moved and when it needs to be moved to/from scalar and vector registers. Dynamic translation can also be done by system software, such as a dynamic binary translator. Alternatively, if the instructions are remapped statically, a compiler or static binary translator needs to be employed. It is out of the scope of this document to describe the specifics of this process.

### BRIEF DESCRIPTION OF THE DRAWINGS

FIG. 1A is block diagram showing a general view of the process of utilizing a SIMD unit for handling permanent and transient errors, in one embodiment of the present invention.

FIG. 1B depicts a Table 1 showing instructions execution frequencies in a random sample.

FIG. 2 depicts a Table 2 showing a mapping of integer arithmetic instructions executed by an integer arithmetic execution unit.

FIG. 3 depicts a Table 3 showing a mapping of integer compare instructions executed by an integer compare execution unit.

FIG. 4 depicts a Table 4 showing a mapping of integer logical instructions executed by an integer logical execution unit.

FIG. 5 depicts a Table 5 showing a mapping of integer rotate instructions executed by an integer logical execution unit.

FIG. 6 depicts a Table 6 showing a mapping of integer shift instructions executed by an integer logical execution unit;

FIG. 7 depicts a Table 7 showing a mapping of floating point arithmetic instructions executed by a floating point arithmetic execution unit.

FIG. 8 depicts a Table 8 showing a mapping of floating point multiply-add instructions executed by a floating point arithmetic execution unit.

FIG. 9 depicts a Table 9 showing a mapping of floating point rounding and conversion instructions executed by a floating point arithmetic execution unit.

FIG. 10 depicts a Table 10 showing a mapping of floating point compare instructions executed by a floating point arithmetic execution unit.

FIG. 11 is a high level block diagram showing an information processing system useful for implementing one embodiment of the present invention.

### DETAILED DESCRIPTION

The present invention utilizes the commonly present Single Instruction Multiple Data (SIMD) unit in modem processors for redundant execution of computation instructions. A SIMD unit is a parallel execution unit where many processing elements (functional units) perform the same operations on different data simultaneously. Often, a SIMD unit is idle, thus it can be used to perform the regular scalar operations normally performed by the processor's integer or Floating Point (FP) units. Since the SIMD unit can do multiple operations in parallel, the original scalar operations can be replaced by a vector operation that executes replicated scalar operations in parallel. Therefore, it does not cause significant performance degradation.

In one embodiment of the present invention, most of the scalar operations are executed on the SIMD unit (such as the commonly known VMX/Altivec SIMD unit available from International Business Machines of Armonk, N.Y.) by replicating the scalar operands into all elements of vector registers and executing vector operations. The result is then compared to detect/recover from permanent and transient errors. In this embodiment, the current mapping between scalar and SIMD operations are analyzed and some hardware extensions that decrease the performance impact and increase the redundancy coverage are proposed.

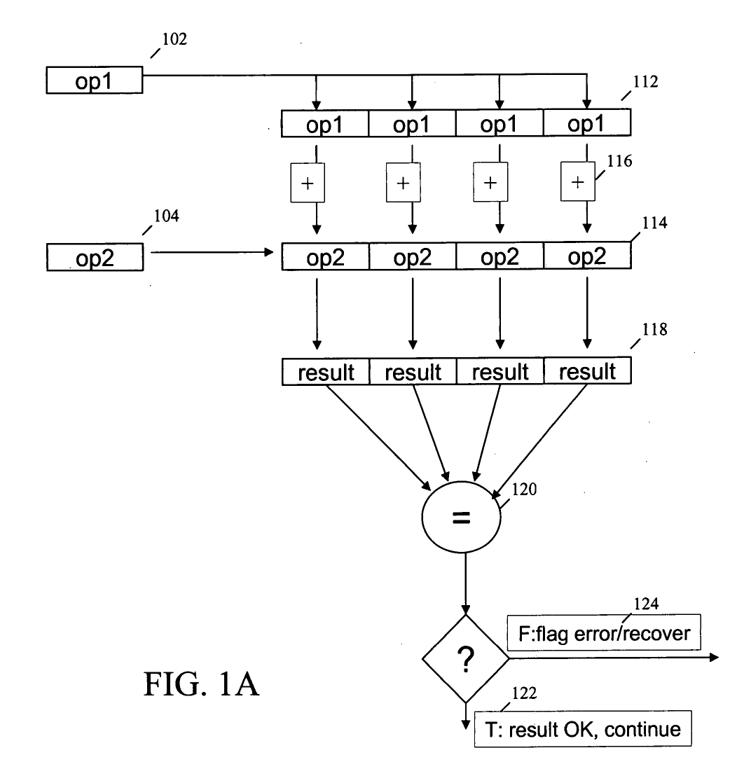

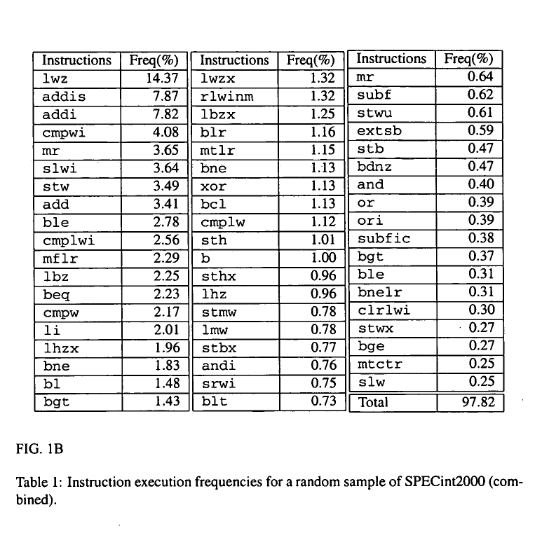

FIG. 1A is block diagram showing a general view of the process of utilizing a SIMD unit for handling permanent and transient errors. In one illustrative embodiment we consider SIMD units having 128-bit registers divided into four separate elements of 32-bits. Therefore a regular 32-bit scalar operation can be replicated up to four times. FIG. 1A shows a SIMD unit having two 128-bit vector registers 112, 114 by way of example. Each 128-bit vector register 112, 114 comprises four 32-bit elements.

The process of using the SIMD unit for redundant scalar computation begins with the scalar operands 102, 104 being replicated into the elements of the SIMD vector registers 112, 114. FIG. 1A shows that scalar operand 102 is replicated into the four elements of the vector register 112 while scalar operand 104 is replicated into the four elements of the vector register 114. Next, the vector operation 116 is performed, producing four results stored in vector register 118.

All results stored in 118 are compared in operation 120. If no errors occurred during the execution of the vector operation 116, then all results are equal and any one of the results 118 are taken as true and correct in step 122. If an error occurred during the execution of the vector operation 116, then all results will not be equal and an error is detected in step 124. Subsequent to step 124, vector operation 116 can be flagged for troubleshooting, debugging or another action. Subsequent to this step, a recovery of the error may be effectuated. For example, if an error is detected, it is possible to perform a voting process and, with high probability, get the correct result and continue normal operation. For example, if all four results stored in 118 are not identical, then the most common occurring result value can be taken as true and correct.

Typically, SIMD units perform a set of operations that maybe be different than other scalar functions units. However, since SIMD units are usually idle in typical applications, current SIMD unit designs can be extended to match most of the operations performed by integer units and therefore cause the SIMD unit to be used for redundant computation. In one embodiment of the present invention, a mode bit can exist on a SIMD unit, in which the unit performs either backward compatible vector operations or redundant scalar operations.

A first step in augmenting a SIMD unit to replicate scalar operations is to determine which scalar operations can be mapped into a SIMD unit. Note that the mapping between the original scalar instructions and the correspondent vector operations executed in the SIMD unit can be done either dynamically or statically. In the case of being done dynamically, the front-end side of the processor translates the scalar instructions to be protected into vector instructions. It also has to decide what data needs to be moved and when it needs to be moved to/from scalar and vector registers. Dynamic translation can also be done by system software, such as a dynamic binary translator. Alternatively, if the instructions are re-mapped statically, a compiler or static binary translator needs to be employed. The specifics of this process are beyond the scope of this patent application.

In mapping scalar operations into vector operations, the following cases may occur:

1) All operands are available in vector registers. In this case, in order to execute the operation no data transfer is needed.

2) Operands are available only in scalar registers. In this case, it is necessary to move data from a scalar register into all elements of a vector register.

3) The result is consumed by a mappable operation. In this case, it is not necessary to move the result back to a scalar register.

4) The result is consumed by a non-mappable operation. In this case, it is necessary to move the result back to a scalar register.

Since moving data between the scalar units and the SIMD units can be expensive, it is most efficient to map operations in such a way that few data movements are necessary.

Below is an identification of the main issues in the mapping between scalar and vectors operations for redundancy. In addition, extensions to SIMD designs are suggested that improve the coverage of the mapping and decrease the performance impact. The commonly known VMX/Altivec SIMD unit available from International Business Machines is considered as the target SIMD unit by way of example only.

The VMX SIMED unit is able to perform most integer and floating point operations. However, there are some design characteristics that can potentially have a major impact in performance when using it for redundant vector operations. These are described below.

First, in typical SIMD units there are few operations that support immediate operands. On the current VMX design, in order to load immediate data into a vector register, it is necessary to store the data to memory and load back into the vector register. Second, there is no scalar-vector data-path. It is sometimes impossible to avoid having data in a scalar register. This occurs when there are un-mappable operations being used. In order to effectuate this, it is necessary to store the scalar register content to memory and load back into the vector register.

Third, there are complications due to memory alignment. The VMX memory operations assume a quad-word aligned address. Even using individual element operations (stvewx and lvewx, for instance) the offset of the element address within a quad-word boundary determines what element in the vector register is the source/destination. Therefore, extra instructions are necessary to compute the position of the desired element inside the vector register. Fourth, there are condition registers. The vector operations affect a different set of condition registers than scalar operations. If the code relies on the use of condition registers, then mapping code must be inserted. Lastly, there is no operation in the VMX unit that compares all elements within the same vector register. This is needed to check if a given computation was successful. Emulating this in software can cause a major performance impact.

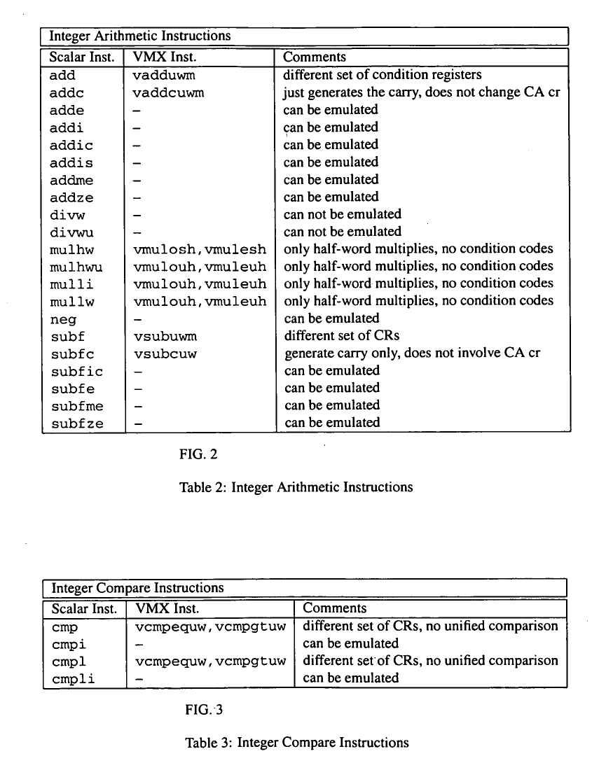

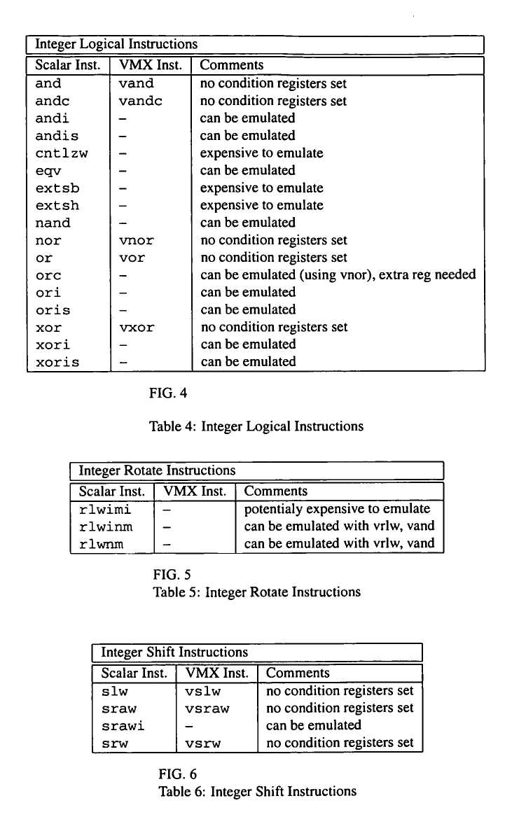

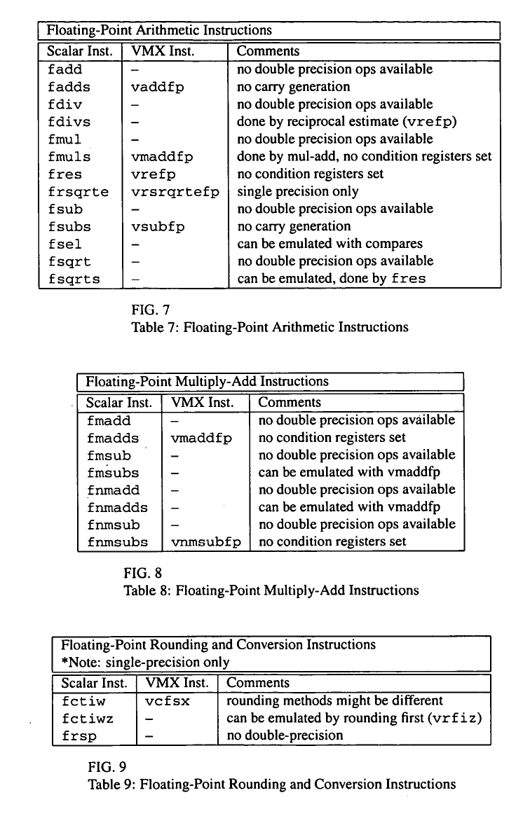

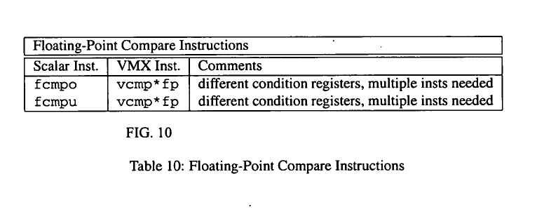

By way of example, below, is a more detailed description of how scalar operations on a PowerPC32 ISA microprocessor can be mapped into the current VMX SIMD design. FIG. 2 depicts a Table 2 showing a mapping of integer arithmetic instructions executed by an integer arithmetic execution unit. FIG. 3 depicts a Table 3 showing a mapping of integer compare instructions executed by an integer compare execution unit. FIG. 4 depicts a Table 4 showing a mapping of integer logical instructions executed by an integer logical execution unit. FIG. 5 depicts a Table 5 showing a mapping of integer rotate instructions executed by an integer logical execution unit. FIG. 6 depicts a Table 6 showing a mapping of integer shift instructions executed by an integer logical execution unit. FIG. 7 depicts a Table 7 showing a mapping of floating point arithmetic instructions executed by a floating point arithmetic execution unit. FIG. 8 depicts a Table 8 showing a mapping of floating point multiply-add instructions executed by a floating point arithmetic execution unit. FIG. 9 depicts a Table 9 showing a mapping of floating point rounding and conversion instructions executed by a floating point arithmetic execution unit. FIG. 10 depicts a Table 10 showing a mapping of floating point compare instructions executed by a floating point arithmetic execution unit.

Floating-point status and control register instructions can only read/write scalar integer registers. For the VSCR (vector status/control register), the mtvscr and mfvscr operations are used. VMX integer load instructions only support register indirect with index addressing mode. Effective addresses are usually quad-word aligned, since the low-order 4 bits are ignored. Unaligned accesses are also supported but the offset in the source/destination vector register depends on the offset of the element in a quad-word boundary.

Integer store instructions are the same for load and store operations. Fortunately, sub-quad-word data can be written in memory. The same alignment issues from integer load instructions apply. Integer load and store with byte reverse instructions can be emulated using the vperm operation, but can be expensive. Integer load and store multiple instructions are not available in VMX.

Floating-point load instructions are the same as integer load instructions. Floating-point store instructions are the same as integer store instructions. With regards to floating-point move instructions, integer and floating-point operations in VMX are performed using the same set of registers. Register moves can be implemented using the vadd operation with a zero value.

Branch instructions branch based on: the contents of the condition registers; the contents of the counter (CTR, scalar) register; and the link register. In order to branch based on data present in vector registers, it is necessary to move the data to a scalar register. The outcome of vector comparisons can be used by branch instructions by using condition register CR6. With regards to cache management instructions, the VMX unit possesses its own set of cache management instructions, however, the semantics are different. The VMX instructions are mainly for pre-fetch buffer stream management.

We now describe a few extensions to the current VMX design to reduce the performance impact of mapping the scalar instruction into redundant vector instructions. A scalar-vector data-path extension would reduce the overhead of moving data between scalar registers and vector registers. An immediate operands extension would also be beneficial. Immediate operations are common, being able to have immediate fields as operands in vector operations would also decrease overhead.

Further, a load-and-splat instruction would increase efficiency. Operands from memory must be replicated in all elements of the vector registers. Having a load-and-splat operation would save the instruction used to replicate the loaded data. In addition, the load-and-splat instruction could accept unaligned addresses and figure out, based on the address, what element should be replicated. A hardware extension that would compare elements at retirement time would also be beneficial. In order to validate that a computation was successful, it is necessary to verify that all elements in a vector are equal. This could be performed at instruction retirement time.

Lastly, condition register mappings would be advantageous. In the current VMX design, there is no mechanism for setting the condition register bits based on vector computations. Since this is commonly used in condition branch instructions, having this support would reduce the overhead involved in mapping vector computation outcome to conditions used by the branch instructions.

When mapping scalar operations into redundant SIMD operations, it is important to take into account the performance impact. The factors that may cause performance impact are described below. The number of floating point units can affect performance. The number of SIMD units might be different from the number of equivalent scalar units, thereby causing performance impact if the code has higher instruction level parallelism. The scheduling of dependent instructions can also affect performance. Usually, it is possible to issue two dependent scalar instructions in consecutive cycles, since many processors have complex bypass networks. This bypass complex may not be present in the SIMD units, so it is possible that dependent vector instructions can't be issued in one cycle. The number of physical vector registers can also affect performance. If the number of physical vector registers in the SIMD unit is smaller than the number of physical scalar registers, lack of physical registers could be a frequent cause of stalls.

Mapping the scalar operations into redundant vector operations can be done either statically or dynamically. Static mapping can be performed by the compiler or an off-line binary translation tool, the result would be a binary executable with SIMD-redundancy natively. The dynamic mapping could either be done in hardware, by the processor or by a dynamic optimization environment. When the processor decides to map a scalar instruction into the SIMD unit, data may have to be moved between scalar registers and vector registers. This decision must also be made dynamically, since the location where operands are stored varies based on previous mapping decisions. The mapping could be done at: 1) decode/crack time during the decode stage, wherein the instruction could be decoded as a vector operation or 2) a issue time when the instruction is about to be issued, whereby the processor can decide (based on SIMD unit usage or configuration register) if the instruction should go to the SIMD unit or the scalar.

An embodiment of the present invention can be embedded in a computer system. A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other-permanent-storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer system to read such computer readable information.

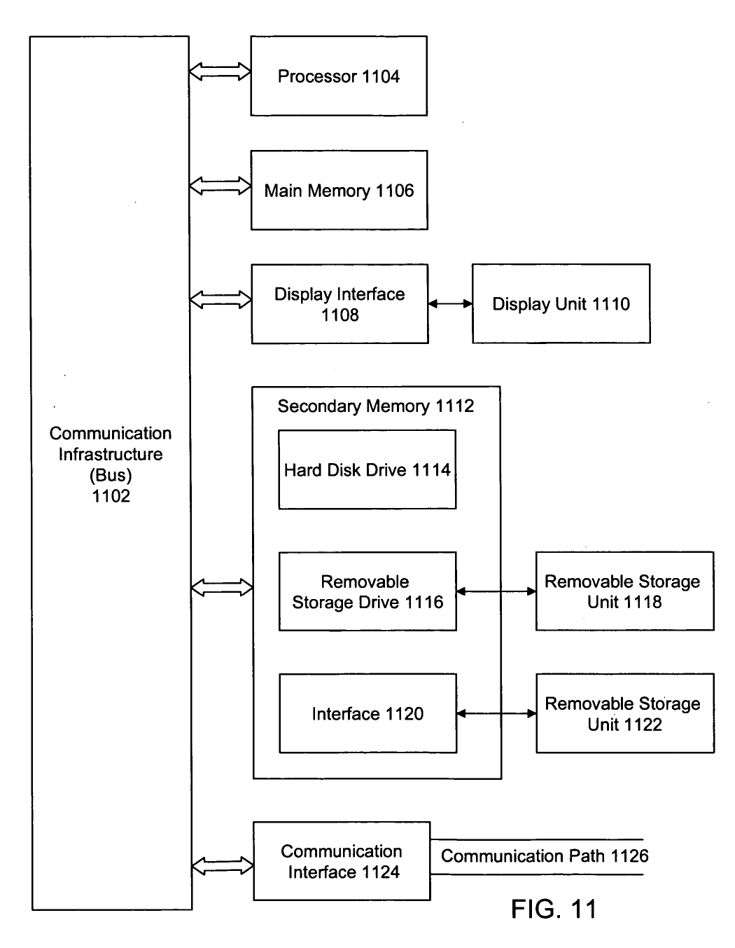

FIG. 11 is a high level block diagram showing an information processing system useful for implementing one embodiment of the present invention. The computer system includes one or more processors, such as processor 1104. The processor 1104 is connected to a communication infrastructure 1102 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 1108 that forwards graphics, text, and other data from the communication infrastructure 1102 (or from a frame buffer not shown) for display on the display unit 1110. The computer system also includes a main memory 1106, preferably random access memory (RAM), and may also include a secondary memory 1112. The secondary memory 1112 may include, for example, a hard disk drive 1114 and/or a removable storage drive 1116, representing a floppy disk drive, a magnetic tape drive, an optical disk drive, etc. The removable storage drive 1116 reads from and/or writes to a removable storage unit 1118 in a manner well known to those having ordinary skill in the art. Removable storage unit 1118, represents a floppy disk, a compact disc, magnetic tape, optical disk, etc. which is read by and written to by removable storage drive 1116. As will be appreciated, the removable storage unit 1118 includes a computer readable medium having stored therein computer software and/or data.

In alternative embodiments, the secondary memory 1112 may include other similar means for allowing computer programs or other instructions to be loaded -into the computer system. Such means may include, for example, a removable storage unit 1122 and an interface 1120. Examples of such may include a program cartridge and cartridge interface (such as that found in video game devices), a removable memory chip (such as an EPROM, or PROM) and associated socket, and other removable storage units 1122 and interfaces 1120 which allow software and data to be transferred from the removable storage unit 1122 to the computer system.

The computer system may also include a communications interface 1124. Communications interface 1124 allows software and data to be transferred between the computer system and external devices. Examples of communications interface 1124 may include a modem, a network interface (such as an Ethernet card), a communications port, a PCMCIA slot and card, etc. Software and data transferred via communications interface 1124 are in the form of signals which may be, for example, electronic, electromagnetic, optical, or other signals capable of being received by communications interface 1124. These signals are provided to communications interface 1124 via a communications path (i.e., channel) 1126. This channel 1126 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 1106 and secondary memory 1112, removable storage drive 1116, a hard disk installed in hard disk drive 1114, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network, that allow a computer to read such computer readable information.

Computer programs (also called computer control logic) are stored in main memory 1106 and/or secondary memory 1112. Computer programs may also be received via communications interface 1124. Such computer programs, when executed, enable the computer system to perform the features of the present invention as discussed herein. In particular, the computer programs, when executed, enable the processor 1104 to perform the features of the computer system. Accordingly, such computer programs represent controllers of the computer system.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. A method for handling permanent and transient errors in a microprocessor, the method comprising:
reading a scalar value and a scalar operation from an execution unit of the microprocessor;
writing a copy of the scalar value into each of a plurality of elements of a vector register of a Single Instruction Multiple Data (SIMD) unit of the microprocessor;
executing the scalar operation on each scalar value in each of the plurality of elements of the vector register of the SIMD unit using a vector operation;
comparing each result of the scalar operation on each scalar value in each of the plurality of elements of the vector register; and
detecting a permanent or transient error if all of the results are not identical.

2. The method of claim 1, the method further comprising:
accepting any result of the scalar operation if all of the results are identical.

3. The method of claim 1, the method further comprising:
flagging the scalar operation for further handling if all of the results are not identical.

4. The method of claim 1, the method further comprising:
accepting the most common result of the scalar operation if all of the results are not identical.

5. The method of claim 1, wherein the element of reading comprises:
reading a scalar value and a scalar operation from an execution unit of the microprocessor, wherein an execution unit includes any one of an integer arithmetic unit, an integer compare unit, an integer logical unit, a floating point arithmetic unit and a floating point compare unit.

6. The method of claim 1, wherein the element of writing comprises:
writing a copy of the scalar value into each of four thirty-two bit elements of a vector register of a SIMD unit of the microprocessor.

7. The method of claim 6, wherein the element of writing comprises:
executing the scalar operation on each scalar value in each of the four thirty-two bit elements of the vector register of the SIMD unit using a vector operation.

8. The method of claim 7, wherein the element of comparing comprises:
comparing each of four results of the scalar operation on each scalar value in each of the four thirty-two bit elements of the vector register.

9. A computer readable medium including computer instructions for handling permanent and transient errors in a microprocessor, the computer instructions including instructions for:
reading a scalar value and a scalar operation from an execution unit of the microprocessor;
writing a copy of the scalar value into each of a plurality of elements of a vector register of a Single Instruction Multiple Data (SIMD) unit of the microprocessor;
executing the scalar operation on each scalar value in each of the plurality of elements of the vector register of the SIMD unit using a vector operation;
comparing each result of the scalar operation on each scalar value in each of the plurality of elements of the vector register; and
detecting a permanent or transient error if all of the results are not identical.

10. The computer readable medium of claim 9, further comprising instructions for:
accepting any result of the scalar operation if all of the results are identical.

11. The computer readable medium of claim 9, further comprising instructions for:
flagging the scalar operation for further handling if all of the results are not identical.

12. The computer readable medium of claim 9, further comprising instructions for:
accepting the most common result of the scalar operation if all of the results are not identical.

13. The computer readable medium of claim 9, wherein the instructions for reading comprise:
reading a scalar value and a scalar operation from an execution unit of the microprocessor, wherein an execution unit includes any one of an integer arithmetic unit, an integer compare unit, an integer logical unit, a floating point arithmetic unit and a floating point compare unit.

14. The computer readable medium of claim 9, wherein the instructions for writing comprise:
writing a copy of the scalar value into each of four thirty-two bit elements of a vector register of a SIMD unit of the microprocessor.

15. The computer readable medium of claim 14, wherein the instructions for writing comprise:
executing the scalar operation on each scalar value in each of the four thirty-two bit elements of the vector register of the SIMD unit using a vector instruction.

16. The computer readable medium of claim 15, wherein the instructions for comparing comprise:
comparing each of four results of the scalar operation on each scalar value in each of the four thirty-two bit elements of the vector register.

17. A microprocessor for handling permanent and transient errors, comprising:
a first execution unit configured for reading a scalar value and a scalar operation from another execution unit;
a Single Instruction Multiple Data (SIMD) unit, including a vector register, configured for:
accepting a copy of the scalar value into each of a plurality of elements of the vector register; and
executing the scalar operation on each scalar value in each of the plurality of elements of the vector register of the SIMD unit using a vector operation; and
a second execution unit configured for:
comparing each result of the scalar operation on each scalar value in each of the plurality of elements of the vector register; and
detecting a permanent or transient error if all of the results are not identical.

18. The microprocessor of claim 17, the second execution unit further configured for:
accepting any result of the scalar operation if all of the results are identical.

19. The microprocessor of claim 17, the second execution unit further configured-for
flagging the scalar operation for further handling if all of the results are not identical.

20. The microprocessor of claim 17, the second execution unit further configured for:
accepting the most common result of the scalar operation if all of the results are not identical.
